(19) United States
(12) Patent Application Publication
(10) Pub. No.: US 2018/0195700 A1
(43) Pub. Date: Jul. 12, 2018

(54) LAMP POST ARRANGEMENT FOR END USER ASSEMBLY

(71) Applicant: Arcadia, Taipei (TW)

(72) Inventor: Te Tai Lee, TAIPEI (TW)

(21) Appl. No.: 15/401,509

(22) Filed: Jan. 9, 2017

(51) Int. Cl. F21V 21/10; F21V 21/12

(52) U.S. Cl. CPC F21V 21/10; F21V 21/12

(57) ABSTRACT

A method of assembling a lamp post arrangement is provided. The method includes providing: a rectangular post having four side portions and first end and second ends, which each comprise a side opening and a vertical opening that are orthogonal to one another and in communication with one another; a pair of nuts, each having a threaded opening and being sized to fit within a respective side opening; at least one bolt; and a wrapping having four side panels. The pair of nuts is inserted into the respective side openings of the first and second ends of the post. The bolt is fastened to the threaded opening of a nut within the side opening of the post. The wrapping is enclosed around the post such that the side panels of the wrapping cover respective side portions of the post. An arrangement of the lamp post is also provided.

### FIELD OF THE INVENTION

The present invention relates to a post arrangement for a lamp or other home furnishings, and a method for assembling the same.

### BACKGROUND OF THE INVENTION

Standing lamps can be made into any number of shapes and sizes for placement within a house or dwelling. Lamps that are above a certain height are often difficult to deliver to an end user because of their size and fragility. Accordingly, there is a need for packaging lamps in a “knockdown” fashion such that the individual parts of the fixture are separated in the package in order to save space.

Knockdown lamps, however, must subsequently be assembled by the end user, which can be difficult due to the number of separate parts included in the package and the lack of mechanical knowledge of the typical end user. U.S. Pat. No. 8,408,762 discloses one example of a post for combining with a light. However, how to actually finish the product of the light post from the various small parts in that construction is not clear from the '762 patent. As such, end users need more guidance in assembling such a light post.

The present invention addresses these and other needs.

### SUMMARY

Presented herein are a lamp post arrangement and a method of assembling the lamp post arrangement. According to a first aspect, a method of assembling a lamp post is provided. In the method, a rectangular post is provided, the rectangular post having four side portions, a first end and a second end. The first end and the second end each comprises a side opening and vertical opening that are orthogonal to one another and in communication with one another. A pair of nuts is also provided, each nut having a threaded opening and each being sized and shaped to securely fit within a respective side opening. Also provided are: at least one bolt sized and shaped to securely fasten to the threaded opening of the nut; and a wrapping having four side panels. In the method, the pair of nuts are inserted into the respective side openings of the first and seconds end of the post. The at least one bolt is then fastened to the threaded opening of at least one nut within the side opening of the post. Further, the wrapping is enclosed around the post, such that the side panels of the wrapping cover both the respective side portions of the post and the side openings of the first and second ends of the post.

According to another aspect, method of assembling a lamp post is provided in which the threaded opening of each nut is aligned with the respective vertical openings of the first and second ends of the post upon insertion of the nuts into the respective side openings.

According to another aspect, while enclosing the post, the wrapping is affixed to the side portions of the post via an adhesive. According to a further aspect, the adhesive is an adhesive layer located on one side of the side panels of the wrapping. In another aspect, the adhesive layer is covered by a removable liner, such that the removable liner is removed before affixing the wrapping to the post.

According to another aspect, a lamp post arrangement is provided. The lamp post arrangement includes a rectangular post having four side portions, a first end and a second end. Each of the first and second ends comprises a side opening and a vertical opening that are orthogonal to one another and in communication with one another. The lamp post arrangement further includes a pair of nuts, each having a threaded opening and being configured to securely fit within respective side openings of the first and second ends. The lamp post arrangement also includes at least one bolt configured to securely fasten to the threaded opening of the nut, and a wrapping sized to cover the four side portions of the post and the side openings of the first and second ends of the post.

According to another aspect, the wrapping comprises an adhesive configured to affix the one surface thereof to the side portions of the post. According to a further aspect, the adhesive is an adhesive layer located on one side of the side panels of the wrapping. According to a further aspect, the adhesive layer is covered by a removable liner.

These and other aspects, features, and advantages can be appreciated from the accompanying description of the invention and the accompanying drawing FIGURE.

### BRIEF DESCRIPTION OF THE DRAWING FIGURES

FIG. 1 shows the principal parts of the post arrangement in accordance with one or more embodiments.

### DETAILED DESCRIPTION OF CERTAIN EMBODIMENTS OF THE INVENTION

By way of overview and introduction, a post arrangement for a lamp and a method for assembling the post arrangement are described herein. While the post arrangement is described throughout the application in conjunction with a lamp, it should be understood that the post arrangement can also be used with other types of standing home furnishings.

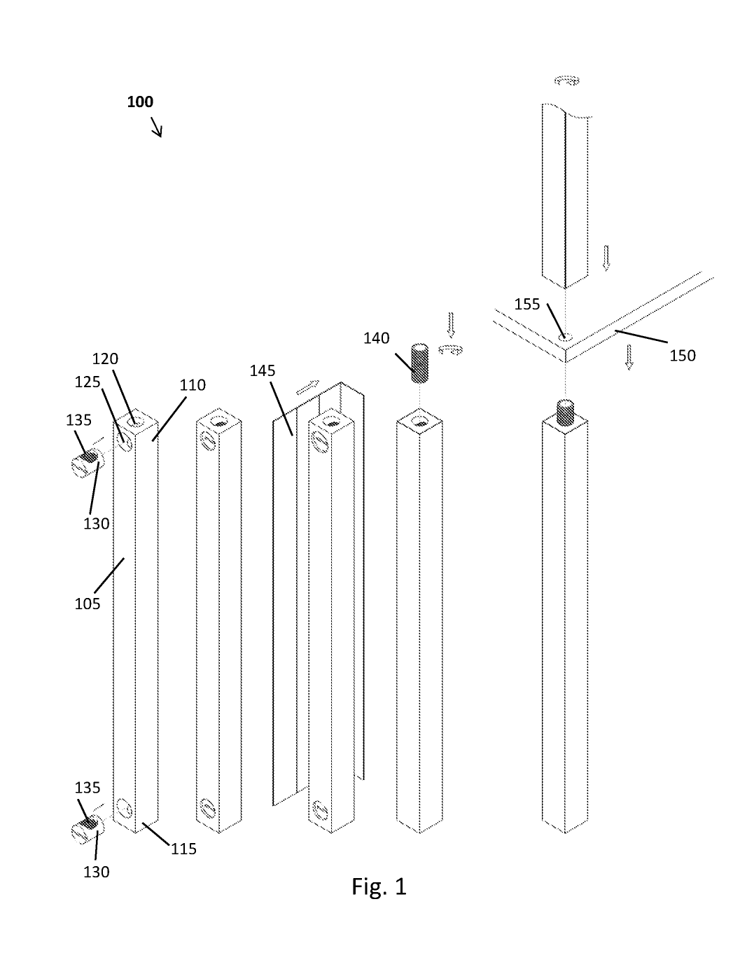

FIG. 1 shows the principal components of a lamp post arrangement 100 in accordance with one or more embodiments. With reference to FIG. 1, the lamp post arrangement 100 includes one or more rectangular posts 105. The rectangular post 105 can be a solid post made of one or more types of materials (e.g., wood, plastic, metal). The rectangular post 105 has a first end 110 and a second end 115. Each of the first and second ends 110, 115 comprises a pair of openings 120 and 125 that are orthogonal relative to one another and are in communication with one another. The openings 120 (vertical openings) can be located on a top and bottom portion of the post 105 aligned with a vertical axis of the post 105. The openings 125 (side openings) can be located on a side portion of the post 105. As shown in FIG. 1, in one or more implementations, the openings 120, 125 can be substantially circular in shape.

With continued reference to FIG. 1, the arrangement 100 further comprises a pair of nuts 130 for each post 105. Each nut 130 comprises a threaded opening 135 that is substantially circular. Each nut 130 is also cylindrical and sized and shaped to securely fit within the opening 125. In one or more implementations, the nut 130 can be securely manually placed within the opening 125. In at least one embodiment, the nut 130 is manipulated using an instrument (e.g., turned using a screwdriver) by a user in order to securely place it within the opening 125. Upon secure placement of the nut 130 in the opening 125, the threaded opening 135 is positioned such that it is in communication with the opening 120 and the threading of the threaded opening is perpendicular to the vertical axis of the post 105. Accordingly, upon secure placement of the nut 130 within the opening 125, the threaded opening 135 is aligned such that the vertical axis of the threaded opening 135 aligns with the vertical axis of the opening 120.

The arrangement 100 also comprises one or more bolts 140. Each bolt 140 is cylindrical and comprises threads that are perpendicular to the vertical axis of the bolt 140. Each bolt 140 is sized and shaped for inserting within the opening 120. Each bolt 140 is also sized and shaped for securely fastening to the threaded opening 135 when the nut is located within the opening 125. Accordingly, the threads of the bolt 140 are sized and shaped to match the threading of the threaded opening 135 such that a portion of the bolt can be securely screwed into the threaded opening 135.

With continued reference to FIG. 1, the arrangement 100 further comprises one or more wrappings 145. Each wrapping 145 is sized and shaped such that it securely wraps (encloses) around the side portions of the post 105. As shown in the embodiment of FIG. 1, the wrapping 145 can have four panels, each of which is sized and shaped to wrap around an entire side portion of the post 105. Optionally, the wrapping 145 can comprise a medium-density fiberboard (MDF) material and have V-grooves partially through one surface to enable a folding wrap step to be taken, as is shown in the aforementioned '762 patent, which is hereby incorporated by reference as if set forth herein. In other embodiments, the wrapping 145 can be a single flexible sheet or discrete sheets sized to cover each side portion of the post.

In one or more implementations, the wrapping 145 is also configured to be affixed to the side portions of the post 105. For example the wrapping 145 can comprise an adhesive layer on one side of each panel, where the adhesive layer can be covered by a removable liner. As such, a user can remove the liner and wrap the wrapping 145 around the post 105 such that each panel of the wrapping 145 is affixed to a side portion of the post 105 via the adhesive. Upon placing (and affixing) the wrapping 145 on the post 105, the wrapping 145 covers the side portions of the post 105 including opening 125. As such, the invention enables the user to produce an uninterrupted post that hides the nuts 130. In certain implementations, the wrapping 145 can be affixed to the post 105 prior to inserting the bolt 140 into the opening 120. In at least one implementation, the wrapping is affixed to the post 105 after inserting the bolt 140 into the opening 120.

In at least one embodiment, at least two posts 105 can be vertically stacked on top of one another, where the posts 105 are attached to one another via the bolt 140. In other words, a bottom portion of the bolt 140 is securely fastened to the threaded opening 135 at the first end 110 of a first post, and a top portion of the bolt 140 is securely fastened to the threaded opening 135 at the second end of a second post. In one or more implementations, the two posts 105 attached via the bolt 140 can be separated via flat portion 150. The flat portion 150 can be a shelf, container, or other type of furnishing for attachment to the posts 105. The flat portion 150 comprises an opening 155 sized and shaped to allow the bolt 140 to pass through it.

In one or more implementations, one or more posts 105 can be attached to a base via a bolt 140 in a substantially similar fashion as the posts attach to one another. For example, the base can include a threaded opening such that a bottom portion of the bolt 140 is securely fastened to the threaded opening of the base, and a top portion of the bolt 140 is securely fastened to the threaded opening 135 at the second end of the post.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

The invention is defined by the points below:

1. A method of assembling a lamp post, comprising the steps of:
providing a) a rectangular post having four side portions, a first end and a second end, each end comprising a side opening and vertical opening that are orthogonal to one another and in communication with one another, b) a pair of nuts, each having a threaded opening and each being sized and shaped to securely fit within a respective side opening, c) at least one bolt sized and shaped to securely fasten to the threaded opening of the nut, and d) a wrapping having four side panels;
inserting the pair of nuts into the respective side openings of the first and second ends of the post;
fastening the bolt to the threaded opening of at least one nut within the side opening of the post; and
enclosing the wrapping around the post, wherein the side panels of the wrapping cover respective side portions of the post and the side openings of the first and second ends of the post.

2. The method of point 1, wherein the step of inserting comprises aligning the threaded opening of each nut with the respective vertical openings of the first and second ends of the post.

3. The method of point 1, wherein the step of enclosing comprises affixing the wrapping to the side portions of the post via an adhesive.

4. The method of point 3, wherein the adhesive is an adhesive layer located on one side of the side panels of the wrapping.

5. The method of point 4, wherein the adhesive layer is covered by a removable liner, and wherein the step of enclosing further comprises removing the removable liner before affixing the wrapping to the post.

6. A lamp post arrangement, comprising:
a rectangular post having four side portions, a first end and a second end, wherein each end comprises a side opening and vertical opening that are orthogonal to one another and in communication with one another;
a pair of nuts, each having a threaded opening and being configured to securely fit within respective side openings of the first and second ends;
at least one bolt configured to securely fasten to the threaded opening of the nut; and
a wrapping sized to cover the four side portions of the post and the side openings of the first and second ends of the post.

7. The arrangement of point 6, wherein the wrapping comprises an adhesive configured to affix the one surface thereof the side portions of the post.

8. The arrangement of point 7, wherein the adhesive is an adhesive layer located on one side of the side panels of the wrapping.

9. The arrangement of point 8, wherein the adhesive layer is covered by a removable liner.
